(19) United States
(12) Patent Application Publication
(10) Pub. No.: US 2006/0235773 A1
(43) Pub. Date: Oct. 19, 2006

(54) Posting adjustments following execution of a period-end closing process

(75) Inventors: Kimberly Ann Nelson, Fargo, ND (US); Ronald H. Schulz, West Fargo, ND (US); Donald Dean Nelson, Moorhead, MN (US); Brett M. Lindemann, Fargo, ND (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/088,704

(22) Filed: Mar. 24, 2005

(51) Int. Cl. G07B 17/00

(52) U.S. Cl. 705/30

(57) ABSTRACT

An accounting system is disclosed that provides support for posting transactions into historical accounting periods, including periods that pre-date the most recent historical period. In one embodiment, when such a transaction has been posted, corresponding closing entries are generated in order to update at least one permanent account (e.g., a retained earnings account) and/or to bring a correct beginning balance forward for one or more balance sheet accounts. Other embodiments pertain to support for a specialized ability to reopen a closed fiscal period by reversing a period-end closing process.

### BACKGROUND OF THE INVENTION

The present invention generally pertains to software applications that facilitate a tracking of corporate finances. More specifically, the present invention pertains to support for adjustments to a historical period after a period-end closing process has been run.

Generally speaking, corporate accounting software, including most enterprise resource planning (ERP) software applications, is configured to support conformance with some level of standardized accounting practices. Most solutions include balance sheets that provide a snapshot of a business' financial condition at a specific moment in time, usually at the close of an accounting period. Most solutions also include revenue, expense, and/or capital withdrawal accounts in the form of temporary accounts that are reset at the end of an accounting period so that they will have zero balances at the start of the next period. The period of a year is a common length of time for an accounting period. Closing entries are the journal entries used to transfer balances of temporary accounts to permanent accounts. After the closing entries have been made, the temporary account balances will be reflected in a more permanent account such as a retained earnings account.

It does happen that after a given year has had its period-end closing process carried out, an adjustment may need to be made to the historical year. For many software solutions, posting adjustments to closed periods is difficult if not impossible. For example, such adjustments are difficult within many ERP systems because either the system will not allow posting into the year that has been closed, or if it does allow this, the retained earnings or beginning balance for any balance sheet account will not be automatically updated. Some systems do support some degree of automatic updating but will only allow transactions to be posted into the most recent historical period.

There are also times when it may be desirable to undo the effects of a period-end closing process. For example, there are times when, after a financial period has been subjected to execution of a period-end closing process, a user finds that the financial period should not yet have been closed. Sometimes it happens that the period-end closing process is prematurely triggered before the end of the applicable fiscal period. In these circumstances, it can be desirable to at least temporarily undo the closing process.

### SUMMARY OF THE INVENTION

Embodiments of the present invention pertain to an accounting system that provides support for posting transactions into historical accounting periods, including periods that pre-date the most recent historical period. In one embodiment, when such a transaction has been posted, corresponding closing entries are generated in order to update at least one permanent account (e.g., a retained earnings account) and/or to bring a correct beginning balance forward for one or more balance sheet accounts. Other embodiments pertain to support for a specialized ability to reopen a closed fiscal period by reversing a period-end closing process.

### BRIEF DESCRIPTION OF THE DRAWINGS

FIG. 1 is a block diagram of a computing environment in which embodiments of the present invention may be implemented.

FIG. 2 is a schematic block diagram of a simplified financial record system.

FIG. 3 is a flow chart diagram illustrating steps associated with a historical adjustment and updating process.

FIGS. 4-6 are tables representing examples of accounting entries made in accordance with embodiments of the present invention.

FIG. 7 is a set of tables containing information pertaining to transactions generated during a period-end closing process.

FIG. 8 is a set of tables representing transactions that would be generated in order to reverse the period-end closing process.

### DETAILED DESCRIPTION OF ILLUSTRATIVE EMBODIMENTS

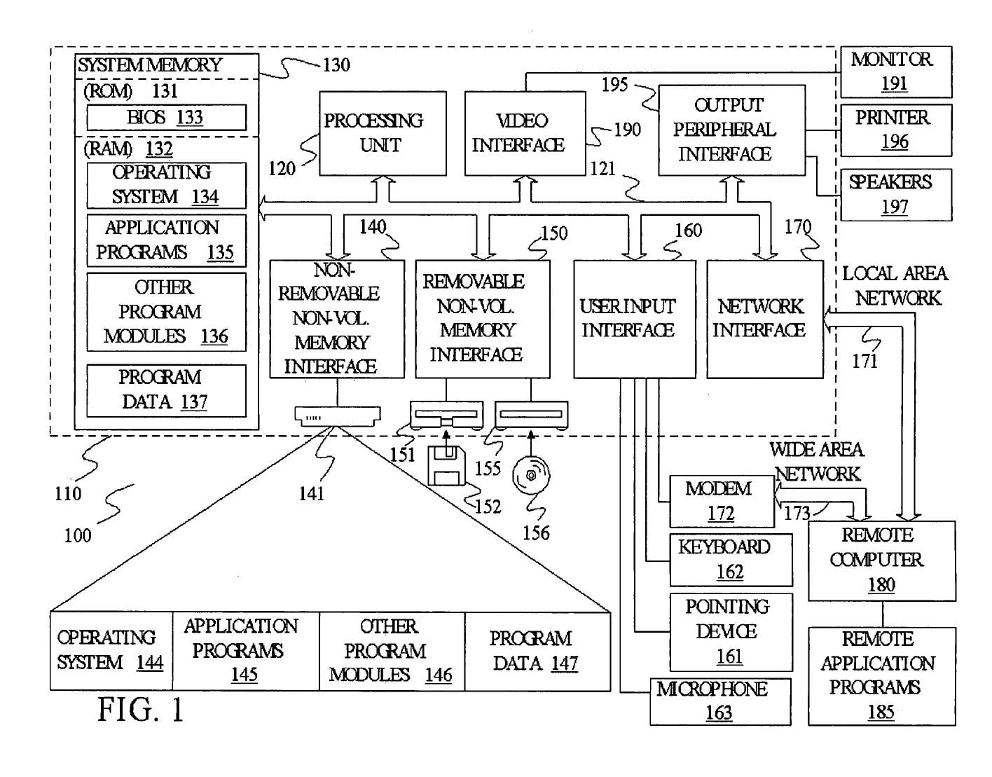

FIG. 1 illustrates an example of a suitable computing system environment 100 in which embodiments of the present invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

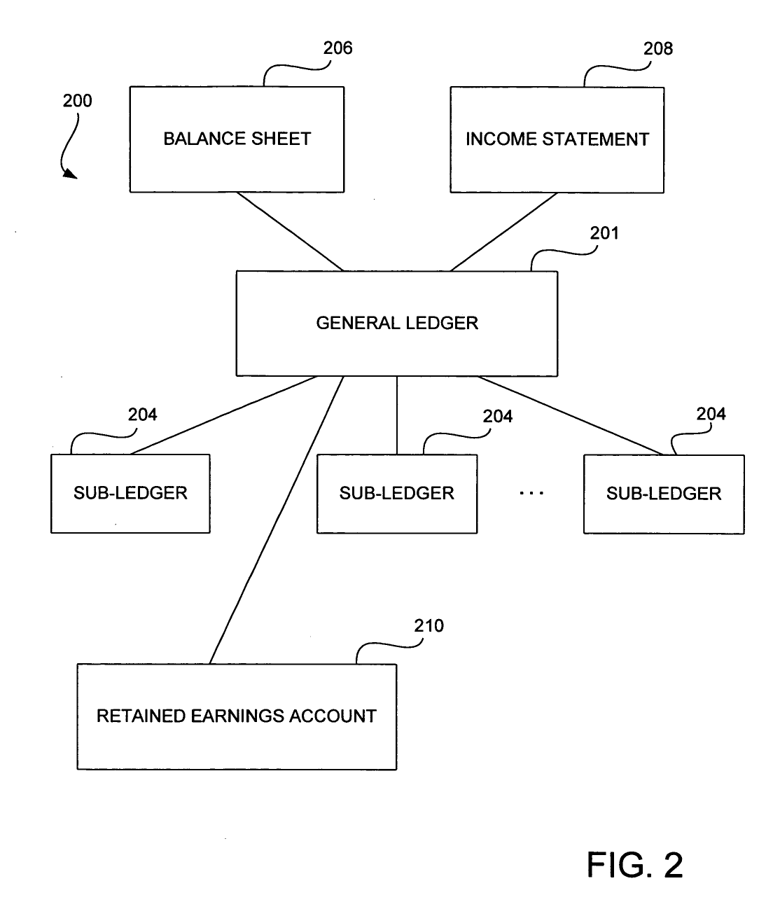

FIG. 2 is a schematic block diagram of a simplified financial record system 200 that represents one context within which embodiments of the present invention can be implemented. The core of system 200 is general ledger 201. All financial transactions flow through general ledger 201 so as to support the creation of a permanent financial history.

System 200 also includes a plurality of sub-ledgers 204 that track specific items such as cash, accounts receivable, accounts payable, payroll, inventory and the like. All entries posted to sub-ledgers 204 will transact through general ledger 201. For example, when a customer pays off a bill with cash, the transaction will be posted to the general ledger and the two appropriate sub-ledgers 204 (i.e., cash and accounts receivable).

Balance sheet 206 and income statement (sometimes referred to as a “profit and loss” statement) 208 are financial documents that are drawn directly from general ledger 201. More specifically, general ledger 201 will contain the balances that make up line items on reports 206 and 208.

Balance sheet 206 is typically configured to provide an overview of financial condition at a given point in time such as at the close of an accounting period. The overview generally includes at least assets (anything the business owns) and liabilities (claims of creditors against assets of the business). In contrast, income statement 208 provides a profit/loss summary during a predetermined period of time, such as a month, quarter or one-year. The summary will generally include revenues and operating expenses for the business during the relevant time period.

It is common for system 200 to be implemented in the specific context of a software application. It should be noted that, for the purpose of illustrating basic components, system 200 is very simply presented. When actually applied in the context of real-world businesses, the structure of such a system can become quite complex, particularly when applied in the context of a large company having a sophisticated enterprise-oriented organization scheme.

It is common for accounting software applications to support conformance with some level of standardized accounting practices. Most applications include reporting functionality in the form of support for balance sheets and/or income statements. In addition, most applications also include revenue, expense, and/or capital withdrawal accounts in the form of temporary accounts that are reset at the end of an accounting period so that they will have zero balances at the start of the next period (commonly one year). Closing entries are the journal entries used to transfer balances of temporary accounts to permanent accounts. After the closing entries have been made, the temporary account balances will be reflected in a more permanent account such as a retained earnings account. A retained earnings account 210 is indicated in FIG. 2.

It does happen that after a given period has been subjected to execution of a period-end closing process, an adjustment needs to be made to that historical period. For many software solutions, posting adjustments to closed periods is difficult if not impossible. For example, such adjustments are difficult within many ERP systems because either the system will not allow posting into the period that has been closed, or if it does allow this, the retained earnings or beginning balance for any balance sheet account will not be similarly updated.

In accordance with one aspect of the present invention, a software application is configured to provide the ability to effectively and accurately post transactions into historical periods (wherein a historical period is a period that has had the period-end closing process run). In one embodiment, following a posting to a historical period, the application is configured to automatically generate correct closing entries as necessary to update one or more retained earnings accounts. In one embodiment, following a posting to a historical period, the application is configured to automatically bring forward a correct beginning balance for any relevant balance sheet accounts. It should be noted that the scope of the present invention is not limited to updating retained earnings or balance sheet accounts but instead extends to updating of any other account such as, but not limited to, an income statement account.

It is common for there to be multiple retained earnings accounts, such as multiple accounts that each correspond to different accounting periods. In accordance with one aspect of the present invention, following a posting to a historical period, a user is provided with an option of closing to either a currently active retained earnings account or a historical retained earnings account. In one embodiment, the currently active retained earnings account is determined by a value set within a collection of setup information associated with a current period-end closing process. In one embodiment, the historical account to which closing occurs is automatically set as the account associated with the period (i.e., a year) receiving the update(s). In accordance with one embodiment, when closing to a historical retained earnings account, the user is also provided with an option to have the system automatically transfer the retained earnings balance to the new retained earnings account if this account has changed over the relevant periods. In one embodiment, the transfer takes place through one or more intermediate accounts as well.

In accordance with one embodiment, when the closing and updating process requires adjustments to be made within historical periods, the system is configured such that created adjustments follow the correct and applicable number schema for each period. For example, if the next number for a period 2002 is 19855, the next number for 2003 is 45890 and for 2004 is 542; the transactions generated for period 2002 would have a journal number beginning with 19855. The entries generated in 2003 would have a journal number beginning with 45890, and 542 for the entries generated in 2004.

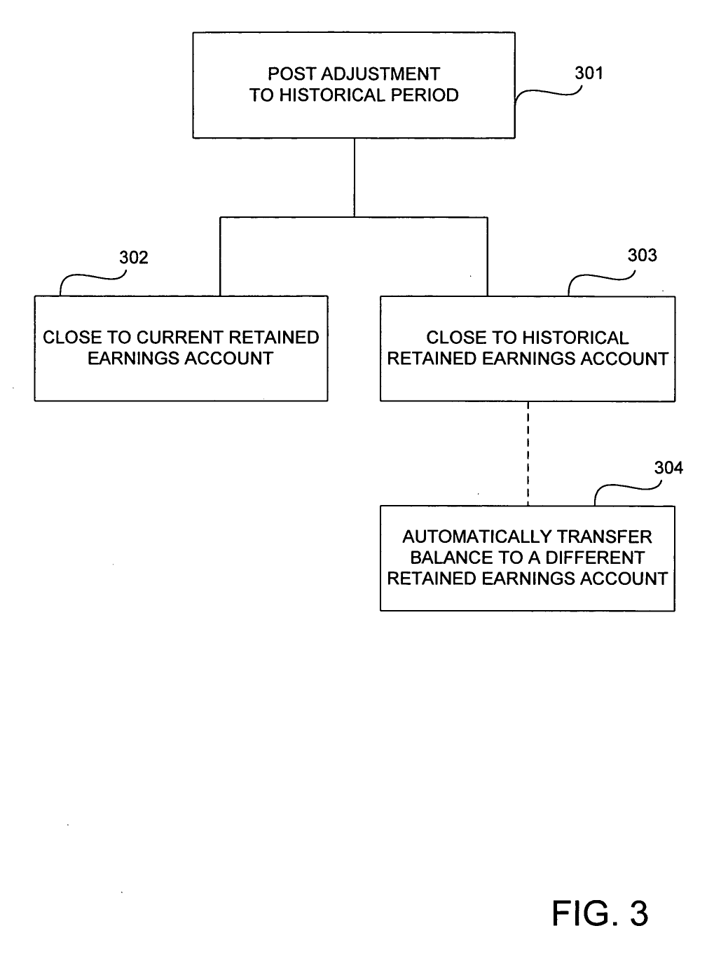

FIG. 3, in accordance with one aspect of the present invention, is a flow chart diagram illustrating steps associated with a historical adjustment and updating process. Block 301 represents an adjustment being posted to a historical (i.e., previously closed) period. Block 302 represents one option wherein the result of the adjustment is ultimately closed to the currently active retained earnings account. Block 303 represents another option wherein the result of the adjustment is ultimately closed to a historical retained earnings account. In accordance with block 304, an optional step, the system automatically updates the retained earnings balance to a different retained earnings account, such as the current retained earning account if this account has changed over the relevant periods. Again, this updating from one account to the next may occur through one or more intermediate accounts depending on dependencies from one account to the next. This type of linked updating will often be the case when updating across historically consecutive accounts.

When configuring an accounting system to accommodate a real-world business, some larger companies will break out their business units into profit centers and cost centers. Typically, a business unit defined as a profit center is run as its own business (i.e., it has revenues and costs associated with those revenues). Some companies will have profit centers that are a child of another profit center, such as regions or departments.

In one aspect of the present invention, to support enhanced functionality for more complex organizations, an accounting system is configured to enable a user to define multiple dimensions for a given account. These dimensions are illustratively usable as identifiers that can serve as a basis for determining which accounts to close to or close from. For example, in one embodiment, the system enables a user to define a specific dimension code(s) to close to in combination with a retained earnings account. The real-world basis underlying a given dimension will vary based on application but examples might include regions, departments, cities, stores, etc.

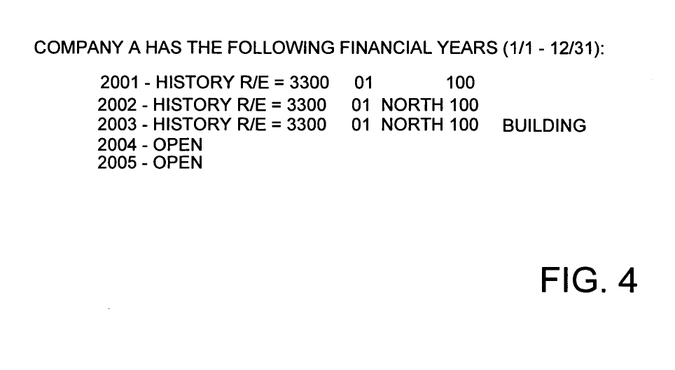

In order to demonstrate characteristics of the present invention, examples of accounting entries will now be provided. FIG. 4 is a table summarizing five different accounting periods for a fictitious Company A. As is noted, each accounting period is one year. The years 2001, 2002 and 2003 are historical years in that they have each previously been subjected to a closing process.

For each of the closed years, the information to the right of the word “HISTORY” represents the retained earnings account and dimension combination to which that closing process was directed. While all three of the closed years list the same retained earnings account (“3300”), they each have different dimensions. The dimensions for 2001 are “01” and “100”. The dimensions for 2002 are “01” and “NORTH 100”. The dimensions for 2003 are “01”, “NORTH 100” and “BUILDING”. Thus, none of the years were closed to the same retained earnings and dimension combination.

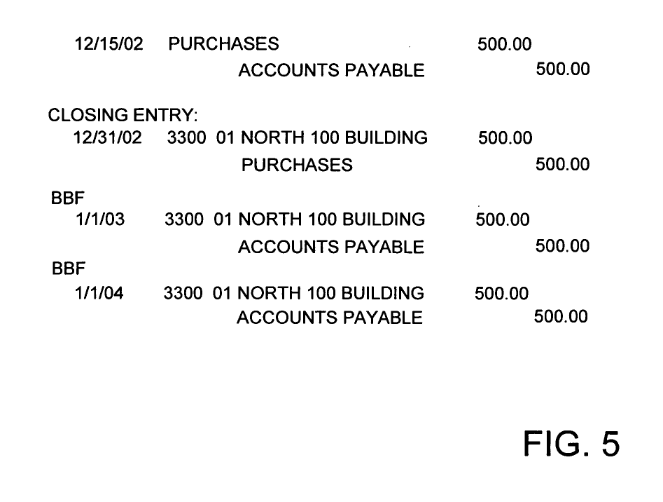

In the context of Company A, FIG. 5 is a table of transactions generated as part of a posting made to a historical period. In accordance with the illustrated example, the user has pre-configured the system to close retained earnings to the current (e.g., most recent) retained earnings account and dimension account combination. An Accounts Payable transaction is entered on Dec. 15, 2002. Because the transaction is entered into a historical year, the system will illustratively run the period-end closing process for each historical year. Transactions generated during the process are to the retained earnings account and dimension combinations as noted in FIG. 4. First, a closing entry is made for Dec. 31, 2002 to the retained earnings account and dimension combination associated with 2003. Then, for the same retained earnings account and dimension combination, the proper balance is brought forward into 2003 and 2004.

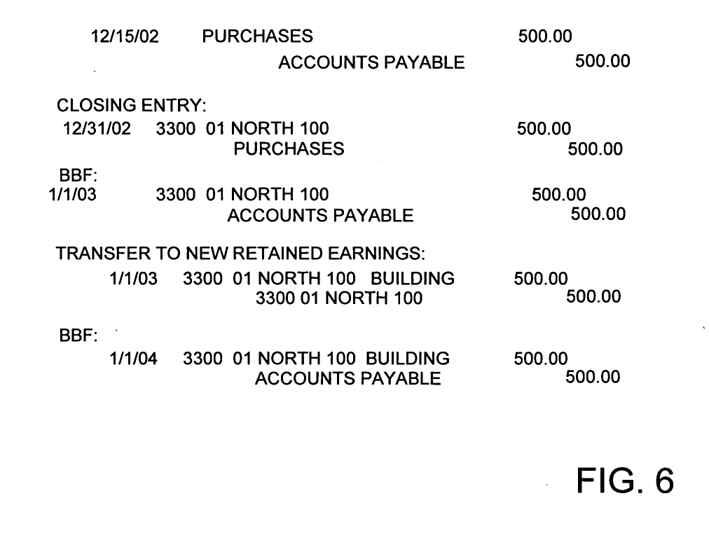

Also in the context of Company A, FIG. 6 is another table of transactions generated as part of a posting made to a historical period. In accordance with the illustrated example, the user has pre-configured the system to close retained earnings to the historical retained earnings account and dimension account combination. The system is illustratively further pre-configured to transfer retained earnings. Again, an Accounts Payable transaction of $500 is entered on Dec. 15, 2002. Because the transaction is entered into a historical year, the system will illustratively generate the transactions to the retained earnings account and dimension combinations noted in FIG. 4. First, a closing entry is made for Dec. 31, 2002 but this time to the retained earnings account and dimension combination associated with 2002. The balance is then brought forward into 2003 for the same retained earnings account and dimension combination. Then, there is a transfer into the 2003 retained earnings account and dimension combination. Finally, the resulting balance is brought forward into 2004 based on the same “01-NORTH 100-Building” dimension combination.

It should be emphasized that the illustrated example could just as easily of incorporated different retained earnings accounts in place of different account/dimension combinations.

In summary, the present invention pertains to configurations to an accounting system that enable a user to go back even multiple years to make an adjustment, wherein the system will essentially run a period-end closing process for each year going forward for that adjustment. For example, if an expense is entered two years back, the system will illustratively automatically close that expense out to that year as retained earnings and then bring the balance forward for the following year and then for the current year.

Additional issues can arise when users change retained earnings accounts. The present invention includes tracking what the retained earnings account was for each historical year. The user then can determine if they want to close to a relevant historical retained earnings account or close to the current retained earnings account. The system illustratively keeps track of journal numbers for each year and utilizes appropriate numbers when making new entries.

As has been alluded to, at the end of a financial period, it is common for period end adjustment transactions to be made into the general ledger. Such adjustments typically include moving balances from revenue and expense accounts to one or more retained earnings accounts, generating zero or more closing entries to move a balance from specific balance sheet accounts to one or more other balance sheet accounts, and/or generating a balance brought forward (BBF) entry for the balance sheet accounts. For many known systems, including known ERP solutions, the process of making period end adjustments has been at least partially automated.

There are times, however, when it may become desirable to undo the effects of a period-end closing process. For example, there are times when, after a financial period has been subjected to execution of a period-end closing process, a user finds that the financial period should not yet have been closed. Sometimes it happens that the period-end closing process is prematurely triggered before the end of the applicable fiscal period.

Another aspect of the present invention pertains to a system that is configured to enable a user to reopen a closed fiscal period. Once reopened, additional transactions can illustratively be posted into the period. Subsequently, the period-end process can be run again for the financial period.

In accordance with one embodiment, during the period-end closing process, the system is configured to add a ‘historical’ attribute to the date range that makes up the designated fiscal period. When a fiscal period is ‘historical,’ some actions, such as posting a new transaction into the period, cannot take place dependent on security and company policies. The present invention provides a second option in the form of an ability to reverse a period-end closing process.

In accordance with one embodiment, the reversing of the period-end closing process occurs in order—last to first period. For example, the following fiscal periods are closed: 2001, 2002 and 2003. If the user needs to reverse the period-end closing for 2001, the user must first reverse the period-end closing for 2003 and then reverse 2002 before being able to reverse 2001.

In one embodiment, reversing the period-end closing process for a fiscal period will do the following:
1. Generate a transaction that reverses the fiscal period's closing transactions that were generated during the period-end closing process
2. Generate a transaction that reverses the balance brought forward (BBF) transactions that were generated during the period-end closing process
3. Remove the ‘Historical’ attribute for the fiscal period's date range In one embodiment, once the fiscal period is reversed, the user is then able to transact using any open fiscal period rules that are in place for the system. The user can then illustratively run the period-end closing process against the fiscal period at a future time.

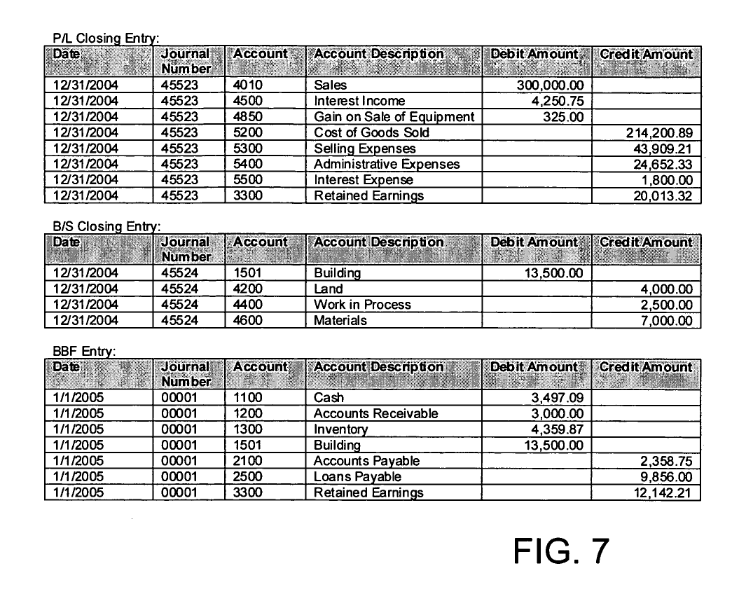

An example will now be provided. FIG. 7 is a set of three tables containing information pertaining to transactions generated during a period-end closing process for a fiscal period of 2004. The entries include profit/loss closing entries, balance sheet closing entries and balance brought forward (BBF) entries.

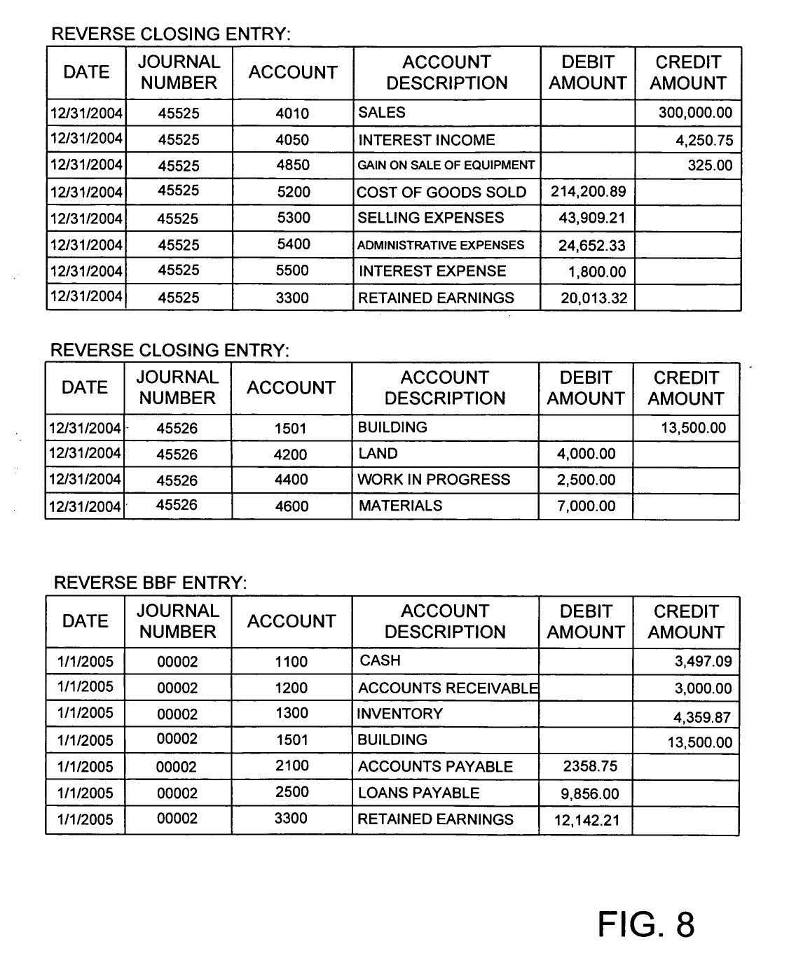

It is now assumed that a user needs to reverse the period-end closing process. FIG. 8 is a set of three tables representing transactions that would be generated in order to reverse the process. During the reversal process, any previously bestowed ‘Historical’ attribute for the 2004 period will illustratively be cleared. The entries include reverse closing entries for the previous profit/loss entries, reverse closing entries for the balance sheet closing entries, and applicable reverse balance brought forward (BBF) entries. By generating the transactions to reverse the period-end closing process transactions, a full audit trail is provided to document what has occurred within the system.

Although the present invention has been described with reference to particular embodiments, workers skilled in the art will recognize that changes may be made in form and detail without departing from the spirit and scope of the invention.

1. A computer-implemented method of processing a financial transaction posted into a historical period that is prior to the most recent historical period, the method comprising:
receiving the transaction to be posted into a historical period that is prior to the most recent historical period; and
facilitating an automatic update of a related record to reflect the transaction.

2. The method of claim 1, wherein facilitating further comprises generating a plurality of closing entries to update a series of historically consecutive retained earnings accounts.

3. The method of claim 1, wherein facilitating further comprises generating an update to a retained earnings account.

4. The method of claim 1, wherein facilitating further comprises generating a closing entry to update a retained earnings account.

5. The method of claim 4, wherein generating a closing entry further comprises generating a closing entry to update a historical retained earnings account.

6. The method of claim 4, wherein generating a closing entry further comprises generating a closing entry to update a current retained earnings account.

7. The method of claim 1, further comprising receiving an input indicative of the related record.

8. The method of claim 7, wherein receiving an input further comprises receiving an input indicative of a particular retained earnings account.

9. The method of claim 7, wherein receiving an input further comprises receiving an input that includes an indication of a dimension.

10. The method of claim 7, wherein receiving an input further comprises receiving an input that includes an indication of an account and dimension combination.

11. The method of claim 1, wherein facilitating further comprises bringing a correct beginning balance forward for a balance sheet account.

12. The method of claim 1, wherein facilitating further comprises automatically adjusting both a retained earnings account and a balance sheet account.

13. The method of claim 1, wherein facilitating further comprises generating an update to a particular account associated with at least one particular dimension.

14. The method of claim 1, wherein facilitating further comprises:
generating a closing entry to a historical retained earnings account; and
transferring the balance of the historical retained earnings account to a current retained earnings account.

15. The method of claim 14, wherein said transferring further comprises choosing a transaction identifier that follows a correct numbering schema associated with the relevant period.

16. The method of claim 1, wherein facilitating further comprises:
generating a closing entry to a historical retained earnings account so as to create a historical retained earnings balance;
transferring the historical retained earnings balance to an intermediate retained earnings account so as to create an intermediate retained earnings balance; and
transferring the intermediate retained earnings balance to a different retained earnings account.

17. The method of claim 16, wherein said transferring further comprises choosing a transaction identifier that follows a correct numbering schema associated with the relevant period.

18. A computer-implemented accounting system that provides an ability to post transactions into a historical accounting period that is prior to the most recent historical period, wherein the historical accounting period is a period that has previously been subjected to a period-end closing process, the system comprising:
an accounting component that enables a user to post a transaction into a historical period that is prior to the most recent historical period; and
an updating component that accounts for said transaction by automatically generating at least one closing entry so as to support an updating of at least one related retained earnings account.

19. The system of claim 18, wherein said updating component is configured to generate more than one closing entry so as to support an updating of more than one related retained earnings account.

20. A computer-readable medium having computer-executable instructions for performing steps that include responding to a transaction posted into a historical period that is prior to the most recent historical period by generating at least one update selected from a set of updates that includes a closing entry to update a retained earnings account and a bringing of a correct balance forward to update a balance sheet account.

21-40. (canceled)
